(19) United States
(12) Patent Application Publication
(10) Pub. No.: US 2007/0130215 A1
(43) Pub. Date: Jun. 7, 2007

(54) Methods and systems for managing multiple updates to time-constrained data

(76) Inventors: Udo Klein, Maximillianseu (DE); Detlef Piuernper, Reichartshausen (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/283,699

(22) Filed: Nov. 22, 2005

(51) Int. Cl. G06F 17/30

(52) U.S. Cl. 707/201

(57) ABSTRACT

Systems and methods are disclosed for managing updates to time-constrained data contained in a database. The disclosed systems and methods may include applying a time constraint to govern permissible relationships between a set of related records contained in a database. An application may comprise a client interface allowing a client to request that multiple updates be performed on a set of related time-constrained records. The system may determine whether the multiple updates are consistent with the applicable time constraint. The multiple updates deemed consistent may be implemented on the set of records. Systems and methods consistent with the principles of the present invention may implement multiple updates without requiring pre-ordering of submitted multiple updates, wherein the number of records existing after implementing the consistent multiple updates may be consistent with the number of records existing before implementation of the multiple updates.

### BACKGROUND OF THE INVENTION

I. Field of the Invention

The present invention generally relates to methods and systems for managing multiple updates to time-constrained data. More particularly, the present invention relates to a protocol for managing conflicts encountered in updating time-constrained data.

II. Background Information

Software applications are often used to maintain databases of time-constrained records. Various time constraints may be placed on a record or groups of records maintained in a database. For example, three common constraints governing relationships between related records are: (i) gaps or overlaps are not allowed; (ii) gaps are not allowed, but overlaps are allowed; (iii) both overlaps and gaps are allowed. An example of a group of records to which one of the above-described time constraints might be applied is employee pay records. An employer may keep a record of employees' pay during their respective employment histories. Each pay entry of an employee may constitute a separate record. For example, if an employee was paid $50,000/year for the first two years of employment, the entry corresponding to that period would constitute one pay record. If after two years, the employee was given a raise to $60,000/year, the entry corresponding to the period in which the increased salary was in effect would constitute a second record.

Software applications responsible for managing time-constrained data records typically do not allow multiple updates to be performed simultaneously. When dealing with a large database, this restriction can be burdensome. It may frequently be necessary to make multiple updates to a group of records. For instance, a governmental department of corrections may maintain a database of the current and former addresses of all former inmates. A certain person's address record may include an address A from January 1999-January 2001 and an address B from February 2001-Present. The department of corrections may learn that the timeframe of Address A should actually be January 1999-May 2001 and that an additional address C should be added between June 2001 and January 2001. To complete the necessary operation in typical systems known in the art, the client would have to complete a first operation to change the timeline with regard to address A, then complete a second operation to insert address C.

Although systems attempting to allow submission of multiple updates have been introduced, such systems have been unable to provide consistent results. For example, some systems have accepted multiple simultaneous update requests from a client and passed the multiple updates through algorithms in the order in which the requests were entered by the client. However, these systems typically relied on the same algorithms that had been used by systems only allowing a single update request at a time. Consequently, because the algorithms were not designed to accept multiple requests, the number and nature of the related records existing after implementation of the multiple updates often varied depending on the order in which the client submitted the requests. Because the outcome of client requests varied depending on the ordering of the request, it was possible that the number of records existing after implementation of a request may not be consistent with the number of records existing before the request. For example, a request to insert a single record might increase the total number of records by two or, alternatively, might only increase the total number of records by one depending on the order in which the requests were submitted.

In an attempt to avoid this problem, certain systems required clients to order their requests in a certain pattern so that consistent results would be obtained. While this may lead to consistent results, it also places a burden on clients to manually pre-order the results before submitting their requests. This can be troublesome and time-consuming, particularly when a large number of update requests must be performed on a single timeline. It also requires the client to know of and understand the need for pre-ordering, rendering the systems less user-friendly and efficient.

### SUMMARY OF THE INVENTION

Consistent with embodiments of the present invention, systems and methods for managing multiple updates to time-constrained data are disclosed.

In accordance with one embodiment, a method for managing multiple updates to time-constrained data may comprise receiving multiple updates submitted by a client. The method may further comprise determining whether the multiple updates are consistent with an applied time constraint. The method may further comprise updating the set of time-constrained records with the multiple updates that are determined to be consistent, wherein the number of records existing after implementing the consistent multiple updates may be consistent with the number of records existing before implementation of the multiple updates without requiring pre-ordering of the multiple updates by the client, such that insertion of one record increases the total number of records by one, deletion of one record decreases the total number of records by one, and modifying an existing record does not change the number of existing records.

According to another embodiment, a system for managing multiple updates to time-constrained data is provided. The system may include an application comprising a client interface operative to allow a client to request multiple updates to a set of related records contained in a database. The system may further comprise a rules-processing engine operative to apply a time constraint to determine whether the multiple updates are consistent. The rules-processing engine may be operative to ensure that the number of records existing after implementing the consistent multiple updates is consistent with the number of records existing before implementation of the multiple updates without requiring pre-ordering of the multiple updates by the client, such that insertion of one record increases the total number of records by one, deletion of one record decreases the total number of records by one, and modifying an existing record does not change the number of existing records.

In accordance with yet another version, a computer-readable medium storing a set of instructions that, when executed, performs a method for managing multiple updates to time-constrained data is provided. The computer-readable medium may be executed by the set of instructions comprising applying a time constraint to a set of related records contained in a database. The set of instructions may also comprise providing a client interface allowing a client to request a set of multiple updates to the set of related records. The set of instructions may comprise applying the time constraint to the multiple updates to determine the consistency of the multiple updates. The set of instructions may comprise updating the set of records with the multiple updates determined to be consistent with the applied time constraint, wherein the number of records existing after implementing the consistent multiple updates may be consistent with the number of records existing before implementation of the multiple updates without requiring pre-ordering of the multiple updates by the client, such that insertion of one record increases the total number of records by one, deletion of one record decreases the total number of records by one, and modifying an existing record does not change the number of existing records.

It is to be understood that both the foregoing general description and the following detailed description are exemplary and explanatory only, and should not be considered restrictive of the scope of the invention, as described and claimed. Further, features and/or variations may be provided in addition to those set forth herein. For example, versions of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 depicts the operation of a system consistent with the principles of the present invention implementing a time constraint allowing gaps and overlaps between related records.

FIG. 2 depicts the operation of a system consistent with the principles of the present invention implementing a time constraint allowing gaps but prohibiting overlaps between related records.

FIG. 3 depicts the operation of a system consistent with the principles of the present invention implementing a time constraint allowing gaps and overlaps between related records.

FIG. 4 depicts the operation of a derive operations function of a system consistent with the principles of the present invention.

FIG. 5 is a flow chart illustrating an exemplary operation of systems and methods consistent with the principles of the present invention.

FIG. 6 is a flow chart illustrating an exemplary operation of systems and methods consistent with the principles of the present invention.

FIG. 7 is a flow chart illustrating an exemplary operation of systems and methods consistent with the principles of the present invention.

FIG. 8 is a flow chart illustrating the operation of a system consistent with the principles of the present invention applying a first time constraint.

FIG. 9 is a flow chart illustrating the operation of a system consistent with the principles of the present invention applying a second time constraint.

FIG. 10 is a flow chart illustrating the operation of a system consistent with the principles of the present invention applying a third time constraint.

FIG. 11 is a flow chart illustrating an exemplary ordering of operations in a system consistent with the principles of the present invention.

FIG. 12 is a diagram illustrating one implementation of a system consistent with the principles of the present invention.

FIG. 13 is a diagram illustrating another implementation of a system consistent with the principles of the present invention comprising a sequencing adaptor.

FIG. 14 is a diagram illustrating another implementation of a system consistent with the principles of the present invention comprising a standardized client interface sequencer.

### DETAILED DESCRIPTION

The following detailed description refers to the accompanying drawings. Wherever possible, the same reference numbers are used in the drawings and the following description to refer to the same or similar parts. While several exemplary versions and aspects of the invention are described herein, modifications, adaptations and other implementations are possible without departing from the spirit and scope of the invention. For example, substitutions, additions and/or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

As embodied herein, methods and systems for managing multiple updates to time-dependent records are provided that allow a software application to process multiple updates without requiring pre-ordering of the requests. Examples of update requests that may be submitted by a client may include (i) insert a new record; (ii) delete an existing record; and (iii) modify an existing record. The methods and systems enable clients to input requested updates in any order, without regard to records that, depending on the time constraint applied, may have an effect on another update request or existing record. The provided methods and systems may manage multiple operations such that the number of output records is consistent with the input operations. For example, the insertion of a single record may increase the total number of records by one. Deletion of a single record may decrease the total number of records by one. Updates to existing records may leave the number of records unchanged. The methods and systems may be operative to process the results and apply rules to ensure consistency of the update requests. The methods and systems may be operative to automatically correct certain requested updates to ensure consistency. Regardless of the order in which the requested updates are submitted, the methods and systems may also be operative to return certain updates to the client for editing or cancellation if it is difficult or impossible for the system to determine the outcome the client intends, further ensuring that accurate, consistent results are provided.

Consistent with the principles of the present invention, a system for managing multiple updates to time-dependent records may include an application comprising a client interface allowing clients to enter multiple updates to a group of related records subject to one or more time constraints. The client interface may be operative to pass update requests submitted by a client to a backend application logic. The backend application logic may pass the requests to a rules-processing engine operative to determine whether the update requests are consistent with the one or more applicable time constraints. After processing by the rules-processing engine, the consistent updates may be implemented in a buffer.

The rules-processing engine may be operative to perform a number of checks on the requested updates. The checks performed by the rules-processing engine may vary depending on the time constraint(s) applied to the set of records. The rules-processing engine may divide the one or more checks it performs into a number of functions. For example, in a system consistent with the principles of the present invention, the rules-processing engine may comprise (i) a “period check” function; (ii) a “timeline check” function; and (iii) a “derive operations” function.

In one aspect, the rules-processing engine may perform a “period check” to verify that all requested updates begin before they end. The “period check” function may be operative to determine whether the “valid to” boundary of a record occurs sooner than the “valid from” boundary—meaning the record ends before it begins. If a record does end before it begins, the “period check” function may generate a message to inform the client of the error.

The rules-processing engine may also perform a “timeline check” to verify that the existing timeline (prior to performing updates requested by the client), which may be stored on a local or network database, is consistent with the applied time constraint. If the existing timeline is not consistent with the time constraint, the system may be operative to return an error. If the existing timeline is consistent with the applied time constraint, the timeline may be copied onto a buffer for evaluation in conjunction with the client-submitted requests to modify the timeline.

The rules-processing engine may perform a “derive operations” function to evaluate the client-submitted requests to update the existing timeline for compliance with the applied time constraint. Once the “derive operations” function determines which of the client-submitted requests may be performed, the rules-processing engine may run an algorithm operative to implement the consistent update requests on the timeline. The derive operations function may be operative to ensure that no duplicate records exist in the group of records existing prior to implementing the operations requested by a client. This may be accomplished in one aspect by determining whether any key field identifiers appear more than once. The derive operations function may also be operative to ensure that a client has not submitted more than one request to modify a single record, as the system could have difficulty determining which of the updates to apply. The derive operations function may also be operative to ensure that the client has not requested modification of a record not present in the group of records existing before the requested updates—meaning that a client may be prevented from requesting modification of a record that was never present at all. In that case, the client would be required to use an “insert” command rather than a “modify” command. In certain aspects, it may be possible to call the derive operations function even if an inconsistency exists in the group of pre-existing records. The derive operations function may be operative to correct such inconsistencies, or to generate a message informing the client of the inconsistencies.

After the changes are made, the rules-processing engine may again perform the “timeline check” to verify that no inconsistent records exist on the timeline after processing by the algorithm.

If inconsistencies are found by the “timeline check” function, an error may be returned to the client and the system may prevent the client from making the inconsistent records persistent on the database on which the records are maintained. However, although the initial “timeline check” may prevent inconsistent timelines existing on the database from being copied onto the buffer for evaluation by the “derive operations” function, the “derive operations” function may be capable of evaluating timelines that are inconsistent with the applied time constraint prior to implementing client-submitted requests, as it may be beneficial to allow the “derive operations” function to handle inconsistent states of the timeline on a buffer. For example, even if a timeline as stored on the database is consistent, the timeline may be placed in a transient inconsistent state during edit cycles prior to the “derive operations” function completing all operations and returning the timeline to a consistent state.

In one aspect consistent with the principles of the present invention, the system may be operative to perform a final check after the requested operations have been performed. In particular, the final check may be operative to identify errors not recognized during initial processing.

Although it is recognized that various time constraints may be applied, systems and methods consistent with the principles of the present invention may be particularly suited to applications applying any one of the following time constraints to related records: (i) overlaps and gaps are allowed; (ii) overlaps are not allowed, but gaps are allowed; or (iii) overlaps and gaps are not allowed. The applied time constraint governs the operation of both the “timeline check” and “derive operations” functions described above. The “timeline check” may verify that the timeline as existing prior to implementing client-submitted requests is consistent, as well as, optionally, to perform a final consistency check on the timeline after consistent client-submitted requests are implemented and prior to the modified timeline being made persistent on the database. The “derive operations” function may determine which of the client-submitted requests to modify the existing timeline are consistent with the time constraint.

No matter which time constraint is applied, the rules-processing engine may operate in a manner such that the number of records existing after implementation of update requests will be consistent with the number of records existing prior to implementation of the requested updates. Various operations that may be performed by the rules-processing engine to ensure consistency of records and update requests are discussed below. Although operations are discussed with regard to the exemplary time constraints mentioned above, it is recognized that other time constraints could be applied by the rules-processing engine in a manner achieving output results consistent with input requests without requiring pre-ordering. Accordingly, the invention is not limited to a rules-processing engine applying one of the three exemplary time constraints discussed herein.

If time constraint (i) is applied, the rules-processing engine may be operative to verify that the “valid to” boundary” of each record is later in time than the “valid from” boundary. If time constraint (ii) is applied, the rules-processing engine may be operative to perform the operation of time constraint (i) and to determine whether any overlapping records will be created by implementing update requests submitted by the client. In performing the requested modifications, the rules-processing engine may execute all delete operations on the timeline. Deleting or delimiting an existing record through an update request is always possible, as deleting or delimiting has no side effects because gaps are allowed between records in time constraint (ii).

For every request to insert a new record or modify an existing record, the rules-processing engine may determine whether an overlap between records would be created. An insert request may be performed if the new record does not intersect an existing record, as it will create no prohibited overlaps. If a new record does intersect an existing record, but does not contain the same “valid from” boundary as the existing record, the system may be operative to delimit the existing record. However, if the newly requested record has a “valid from” boundary beginning after the “valid from” boundary of an existing record and a “valid to” boundary ending before the “valid to” boundary of the existing record, the system may be operative to delimit the “valid to” boundary of the existing record to abut the “valid from” boundary of the requested record, rather than splitting the existing record into two portions. Therefore, the insertion of a single record will raise the total number of records by one. If a newly requested record comprises the same “valid from” boundary as an existing record (or another newly requested record), the insertion may not be performed and a message may be generated to inform the client of the error. At that point, the client may edit or delete the update request. The system may also be operative to prevent the deletion of an existing record by the insertion of a new record, ensuring that the insertion of a new record will raise the total number of records by one and allowing the system to operate in a predictable manner.

If time constraint (iii) is applied, the rules-processing engine may be operative to perform the operations of time constraint (ii) and to determine whether any gaps between adjacent records will be created by implementing the update requests submitted by the client. In a system applying time constraint (iii), records may be required to possess a different “valid from” boundary. In certain aspects, the “valid to” boundary of each record may be calculated based on the “valid from” boundary of the subsequent record, such that the “valid to” boundary of a first record is immediately adjacent the “valid from” boundary of a second, subsequent record. Thus, the “valid from” boundary of a first record may change with the insertion of a second record beginning after the first record and before the end of the first record. In this case, the “valid from” boundary of the first record would change to abut the “valid from” boundary of the second record. Similarly, the “valid to” boundary of a first record may be extended by the deletion of a second record that had a “valid from” boundary adjacent the “valid to” boundary of the first record. In that case, the “valid to” boundary of the first record would be extended to the former “valid to” boundary of the second record. In this manner, creation of gaps between adjacent records may be prevented.

The “valid to” boundary may be read-only, such that the client is allowed to enter only the “valid from” boundary of each record. Thus, the last-in-time record will extend to infinity, or to the end of an applicable reference period (discussed below). The system may also generate a message to notify the client that the “valid to” boundary of a record has been changed by an update request. In evaluating multiple update requests, the rules-processing engine may sort the “valid from” boundaries of the timeline as modified by the client requests in order from first-in-time to last-in-time. Once the rules-processing engine has verified that the records are correctly sorted, it may be operative to set the “valid to” boundary of each record to abut the “valid from” boundary of the immediately-subsequent record, as described above.

The rules-processing engine may also be operative to apply a reference period to a group of related records. The reference period may be a time period within which all records must be located. For example, with regard to a group of records tracking an employee's base salary, the reference period may be the employee's period of employment. The system may require that each employee's base pay record exist continuously throughout the period of employment, and may further require that no base pay record exist outside the period of employment. The system may therefore be operative to determine both whether implementation of a requested update would (i) create a record outside the reference period; and (ii) result in the set of records not being continuous over the entire reference period.

For example, the existing record A for a person employed from January 2000-January 2003 may indicate a base pay of $80,000 over the entire time period. It may later be discovered that the employee actually had an initial salary B of $60,000 from January 2000-January 2001, and later had a salary C of $90,000 from January 2002-January 2003, and a data clerk may make updates reflecting those changes. In revising the salary records, the clerk may incorrectly enter a request to insert salary B from January 1999 to January 2001 and salary C from January 2002-December 2002. In this case, the reference period would be the employee's period of employment, January 2000-January 2003. The system may be operative to recognize that the requested updates create inconsistencies with regard to the reference period. The system may be operative to return the requested updates to the client and indicate that the request to insert Salary B is inconsistent because it is partly outside the reference period. The system may also return the request to insert salary C as inconsistent because the update would leave a portion of the reference period uncovered. Systems applying time constraint (iii) may be particularly suited to the application of a reference period, in order to apply beginning and ending boundaries to the “no gaps” requirement of time constraint (iii). Alternatively, in systems with no reference period, the records having the earliest “valid from” and the latest “valid to” boundaries may stretch to infinity in antecedent and posterior directions, respectively.

In one aspect consistent with the principles of the present invention, when a client requests an update that would violate an applicable reference period, the system may modify the timeline in a manner consistent with the applied time constraint, allowing the requested update to be implemented. For example, if the client submits a request to insert a record that begins before the beginning of the reference period and ended within the reference period, the system may be operative to automatically truncate the request such that it begins concurrent with the beginning of the reference period. The same principle could apply to terminate a requested insert concurrent with the end of the reference period if the submitted request called for the record to begin during the reference period but terminate after the end of the reference period. In certain aspects, the system may not modify a submitted request that is wholly outside the reference period, as it is difficult to deduce the intent of the submitting client.

As mentioned above, the system may be operative to extend to the end of the reference period a request that would otherwise fall within the reference period but not entirely cover the vacant portion of the reference period. Alternatively, if a previously existing record is located between the end of the requested update's boundary and the reference period boundary, the system may extend the request to abut the adjacent record. However, in certain aspects, the system may not extend a request to cover a gap in the reference period created by two simultaneously submitted requests, due to the difficulty in determining where the boundary should be drawn between the two requests.

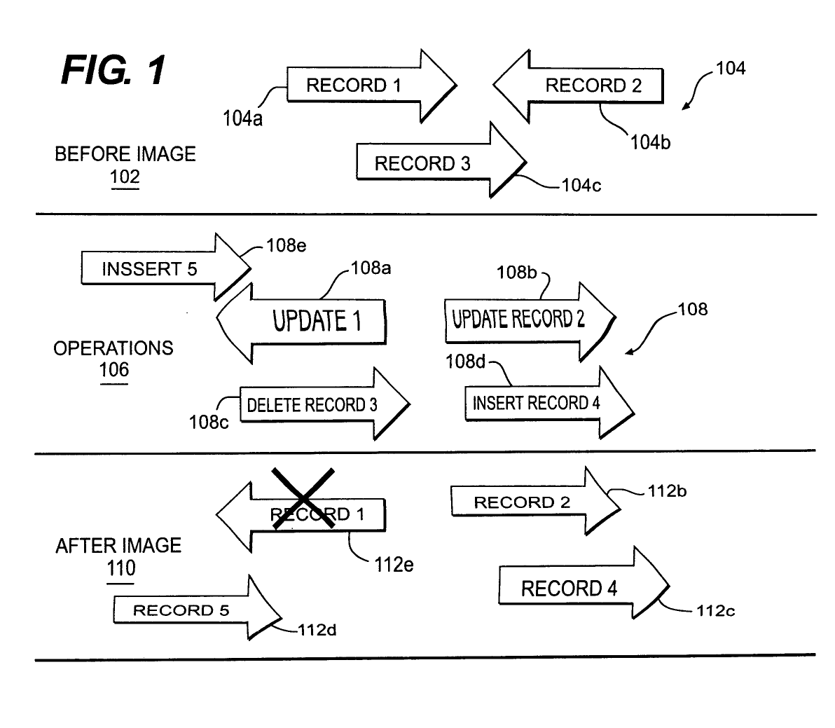

With reference to FIG. 1, the operation of a system implemented in conjunction with an application applying a time constraint that allows gaps and overlaps between related records is described. In FIGS. 1-4, each arrow represents a record or a request to update a record. The beginning of an arrow represents the start time of a record or requested update, and the end (or tip) of an arrow represents an end time. Time is depicted as flowing from left to right. FIG. 1 illustrates a “before” image 102, depicting a group of related records 104a-c existing prior to implementation of multiple update requests submitted by a client. FIG. 1 also illustrates an “operations” image 106 representing a number of update requests 108a-e submitted by the client, as well as an “after” image 110 representing the group of records 112a-d after consistent updates are performed and inconsistent updates are rejected and returned to the client for editing or cancellation.

In certain aspects, the system may apply a key to each record, allowing the records to be uniquely identified. The key may comprise, for example, an identifier of the timeline with which the record is associated, the record's “valid from” boundary and the record's “valid to” boundary. In one aspect, the key may comprise a globally unique identifier. For purposes herein, individual records may be identified by a numeral representing a key field identifier. The “timeline check” function, described above, may verify that no duplicate keys exist on a single timeline. FIG. 1 depicts an existing record 104a in “before” image 102 and an update request 108a in operations image 106. Because the update request 108a for record 104a calls for record 104a to terminate before it begins, the update request corresponding to record 1 may be returned to the client as inconsistent, as depicted in “after” image 112a. “Operations” image 106 also depicts a request 108c to delete pre-existing record 104c.

In one aspect, the system may be operative to evaluate records existing before the update request to determine whether they are consistent with the applicable time constraints. As illustrated in FIG. 1, a client may submit an update request to correct a pre-existing record 108b that, as previously stored, ended before it began (see 104b), and the correction request may be implemented (112b). As mentioned above, inconsistent timelines may be stored in a buffer in which update operations are performed. If a correction of record 104b was not submitted by the client, the system may be operative to return record 104b as inconsistent after the client submitted his requested update requests and the system checks the records for inconsistencies, in order to avoid an inconsistent state being made persistent on the database.

“Operations” image 106 also depicts a request to insert a record 108e. Because the system illustrated in FIG. 1 allows gaps between records, the system may be operative to insert record 112d as requested, despite a gap existing between record 112d and record 112b after all operations are performed. Similarly, record 112c may be inserted, despite creating an overlap between record 112b and record 112c, as the time constraint of the illustrated system allows overlaps.

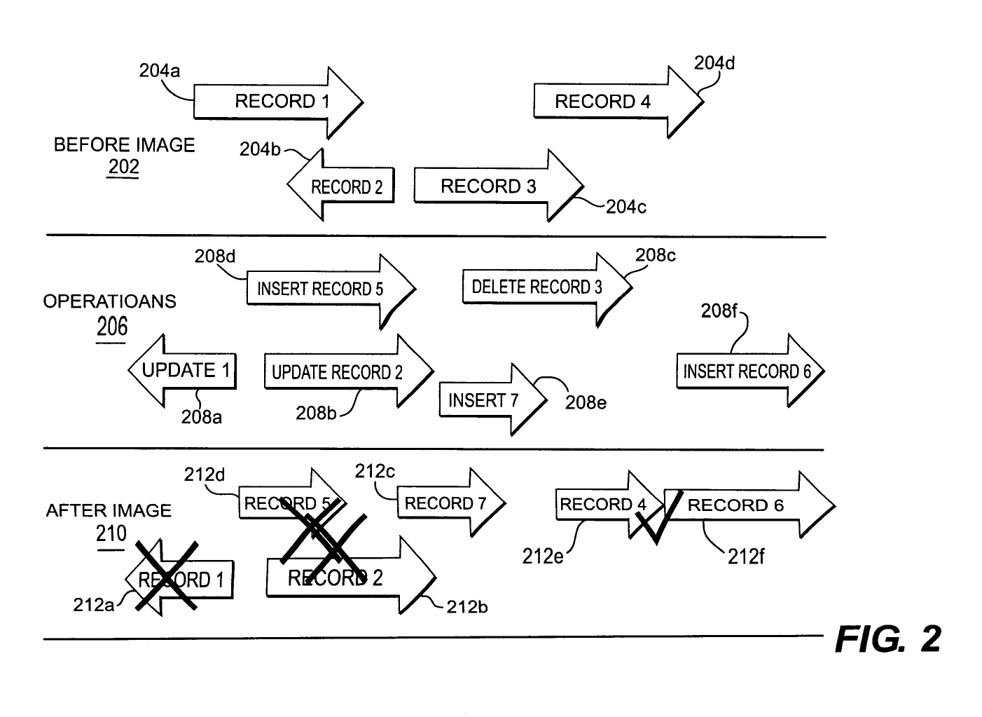

With reference to FIG. 2, the operation of a system implemented in conjunction with an application applying a time constraint allowing gaps but prohibiting overlaps between related records is described. FIG. 2 depicts a “before” image 202 comprising a group of previously existing records 204a-d, an “operations” image 206 comprising a set of requested updates 208a-f submitted by the client, and an “after” image 210 reflecting the set of records 212a-f after processing of the update requests, with an “X” denoting operations that are not performed, for reasons discussed below. “Operations” image 206 depicts requests to update record 208e and insert a record 208d. Because overlapping records are prohibited by the time constraint applied to the system illustrated in FIG. 2, the system may determine that the client's request to insert record 208d and to update record 208e is inconsistent because it would create overlapping records. The request to update record 208a shown in “Operations” image 206 may also be determined to be inconsistent because it would cause record 1 to terminate before it began. The request to insert record 208e is deemed consistent even though it creates a gap between record 212e and record 208e, however, because gaps are allowed by the processing rules of the system illustrated in FIG. 2. Overlapping records will not be created by the insertion of record 208e, due to the simultaneous request 208c to delete previously existing record 204c.

FIG. 2 also illustrates a feature that may be present in certain aspects consistent with the present invention to correct errors in client input without requiring the client to manually correct the error. “Before” image 202 depicts record 204d as existing before the implementation of the client's update requests. “Operations” image 206 depicts a record-insert request 208f. Insertion of record 6 without modification of record 204d would cause an overlap, prohibited under the time constraint applied to the system portrayed in FIG. 2. However, in response to a request to insert a record that would create an overlap with a previously existing record, the system may truncate the previously existing record such that it abuts the newly inserted record rather than creating an overlap. In certain aspects, this feature may not be operative to modify two updates simultaneously submitted that create an overlap, due to the difficulty in determining which record to truncate.

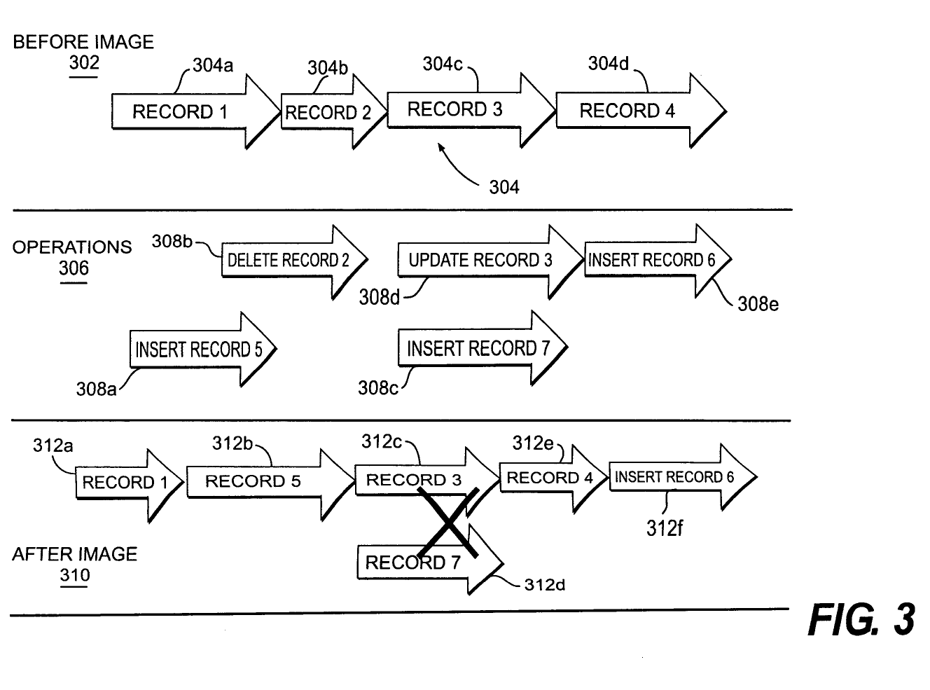

With reference to FIG. 3, the operation of a system applying a time constraint that prohibits both gaps and overlaps between related records is described. FIG. 3 depicts a “before” image 302 comprising a group of previously existing records 304a-d, an “operations” image 306 comprising a set of requested updates 308a-e submitted by the client, and an “after” image 310 reflecting the set of records 312a-f after processing of the update requests. In one aspect, the records contained in a system applying a time constraint prohibiting gaps and overlaps may be managed by implementing the end time, or “valid to” boundary, of each record as a read-only field. Thus, the client may enter a record by entering the begin time, or “valid from” boundary, of the record. The system may be operative to terminate the inserted record at the “valid from” boundary of the subsequent record. Alternatively, if no subsequent record exists, the system may set the “valid to” boundary of the inserted record at the end of the reference period. If a client inserts a new record into an existing timeline by entering the “valid from” boundary, the system may operate to re-compute the “valid from” boundary of the record previously occupying that space on the timeline to abut the “valid to” boundary of the newly inserted record. The system may further compute the “valid to” boundary of the inserted record based on the “valid from” boundary of a pre-existing record beginning subsequent to the “valid from” boundary of the newly inserted record. However, if the client requests that two records have the same “valid from” boundary, the system may determine the records to be inconsistent and prompt the client to edit or cancel the records to resolve the inconsistency.

As depicted in “operations” image 306, requests to modify and/or insert a new record submitted by the client may result in creation of overlaps and gaps between the records. However, as depicted in “after” image 310, the system may be operative to automatically correct certain errors caused by requested updates 308 submitted by the client. For example, the client may submit a request 308b to delete record 304b and a record-insert request 308a. However, implementing record-insert request 308a and deleting record 304b would create an overlap between requested insert 308b and record 304a, as well as a gap between requested insert 308a and record 304c. The system may therefore be operative to automatically truncate record 304a to abut requested insert 308a, resulting in records 312a, 312b. The system may also be operative to extend requested insert 308a to abut the subsequently beginning record. In this manner, the system may be operative to prevent creation of inconsistent records. However, in certain aspects, these features may not truncate or extend records when the relationship involved is between two simultaneous updates as opposed to between one previously existing record and one update request. In such instances, the update request may be returned to the client for editing or cancellation.

The system may also be operative to return an error to the client if implementing the client request would cause two records to begin at the same time. For example, the client may request that record 304c be updated (308d) and submit an insert-record request 308c. Implementing requests 308d and 308c would cause the records to begin at the same time. The system may be operative to deem requests 308d and 308c inconsistent and return them to the client for editing or cancellation due to the difficulty in determining the client's intention.

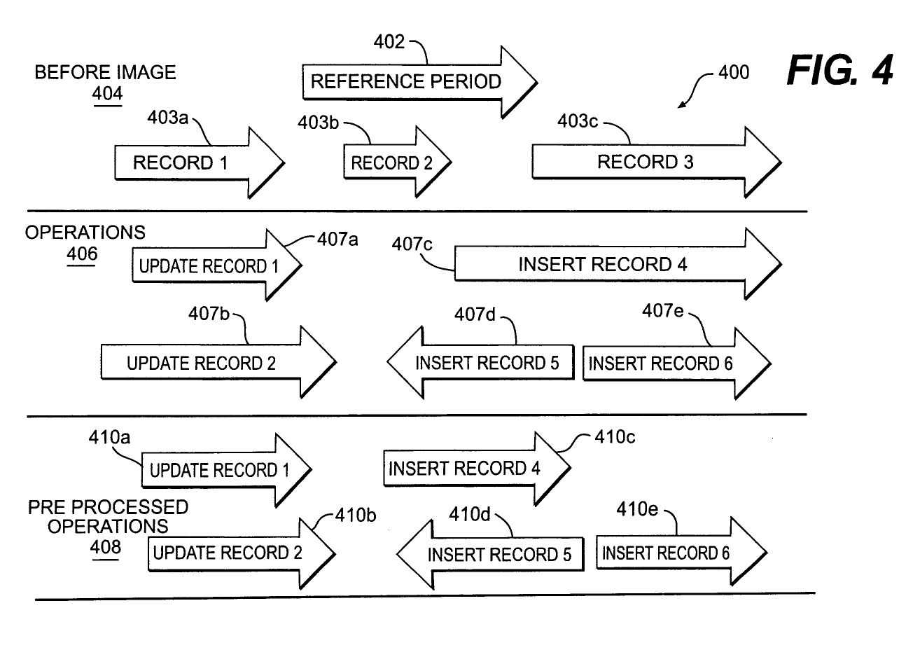

FIG. 4 illustrates the pre-processing of a group of records by an exemplary “derive operations” function in a system 400 applying a reference period 402. FIG. 4 illustrates a group of pre-existing records 403a-c in a “before” image 404, and a request to modify record 407a, modify record 407b, insert record 407c, insert record 407d and insert record 407e in a “requested operations” image 406. The results of “pre-processing” operations (410a-e) are shown in a “pre-processed operations” image 408. Because record 403a was never inside the reference period 402, the “derive operations” function may leave record 403a unaffected during the pre-processing stage, deferring treatment of the record until the functions determined by the time constraint are applied. Similarly, record-insert request 407c may be left unaffected, as it is a newly requested record and is wholly outside reference period 402. Insert-record request 407d may be left unaffected by the pre-processing operations, as its “valid to” boundary occurs before its “valid from” boundary.

Because the update request 407b would leave record 403b partially within reference period 402, the pre-processing operations may be operative to delimit its “valid from” boundary to fit within the reference period. Similarly, because the record-insert request 407c is partially within reference period 402, its “valid to” boundary may be delimited to fit within reference period 402 (see 410c).

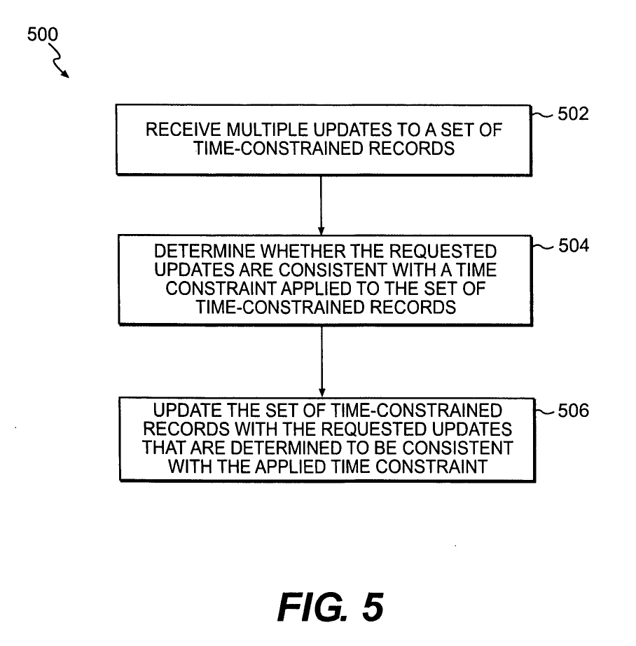

FIG. 5 is a flow chart illustrating the operation of systems and methods consistent with the principles of the present invention. As illustrated, a system 500 may receive multiple updates to a set of time-constrained records (502). The system may determine whether the requested updates are consistent with a time constraint applied to the set of time-constrained records (504). The system may update the set of time-constrained records with the requested updates that are determined to be consistent with the applied time constraint (506).

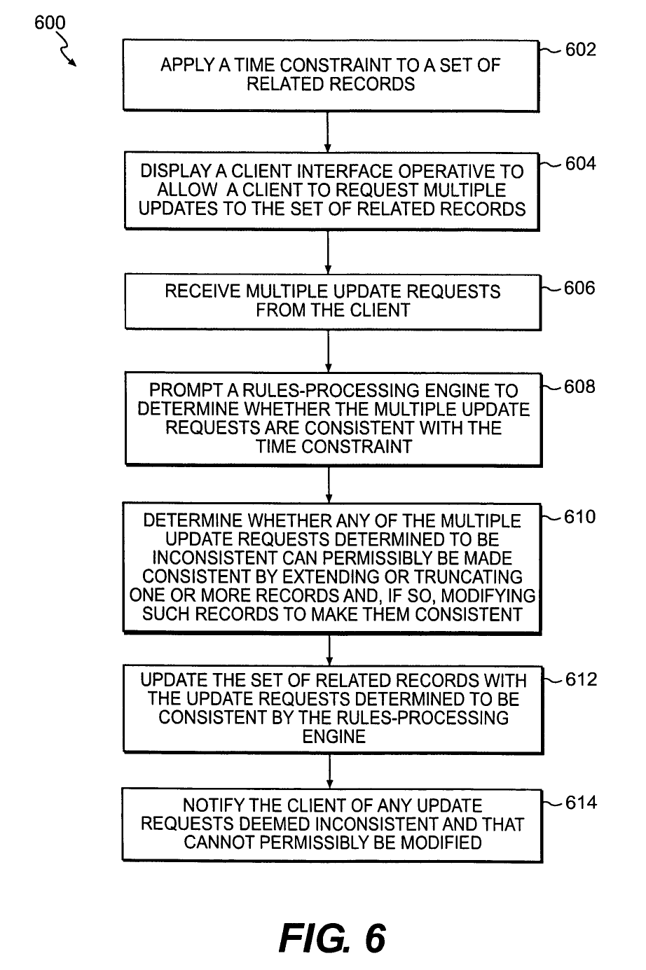

FIG. 6 also illustrates the operation of systems and methods consistent with the present invention. As illustrated, a system 600 may apply a time constraint to a set of related records (602). System 600 may display a client interface operative to allow a client to request multiple updates to the set of related records (604). System 600 may be operative to receive multiple update requests from the client (606). System 600 may prompt a rules-processing engine to determine whether the multiple update requests are consistent with the time constraint (608). System 600 may determine whether any of the multiple update requests determined to be inconsistent can permissibly be made consistent by extending or truncating one or more records and, if so, modifying such records to make them consistent (610). System 600 may update the set of related records with the update requests determined to be consistent by the rules-processing engine (612). System 600 may notify the client of any update requests determined to be inconsistent with the applied time-constraint and that cannot permissibly be modified (614).

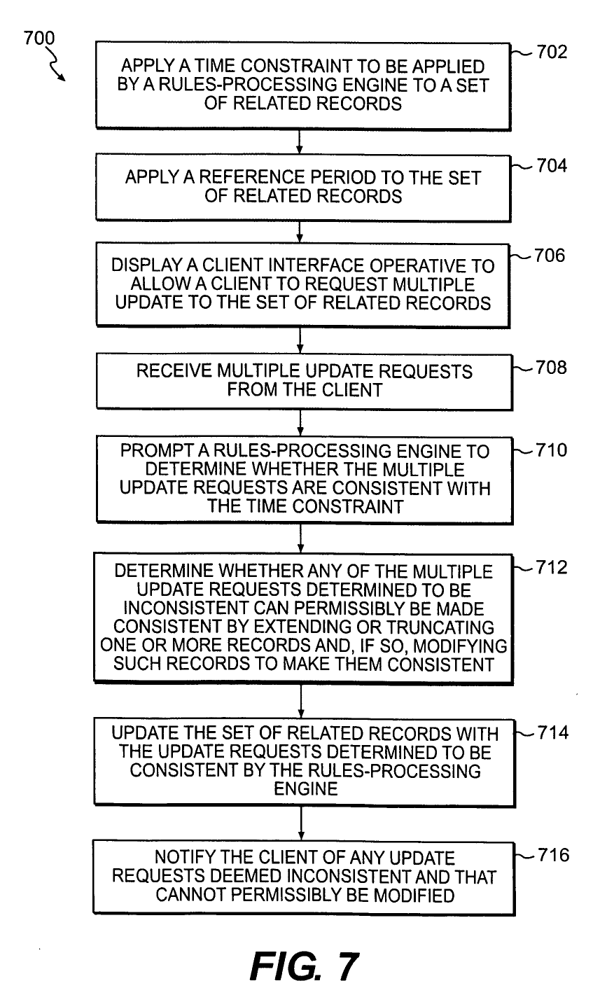

FIG. 7 illustrates another implementation 700 of systems and methods consistent with the present invention. System 700 may include applying a reference period to the group of related records (702). In addition, system 700 may include operations 704-716 identical to operations 602-614 illustrated in FIG. 6. As discussed above, application of a reference period may add additional constraints to the set of records. The additional constraints may vary depending on the particular time constraint applied to the records.

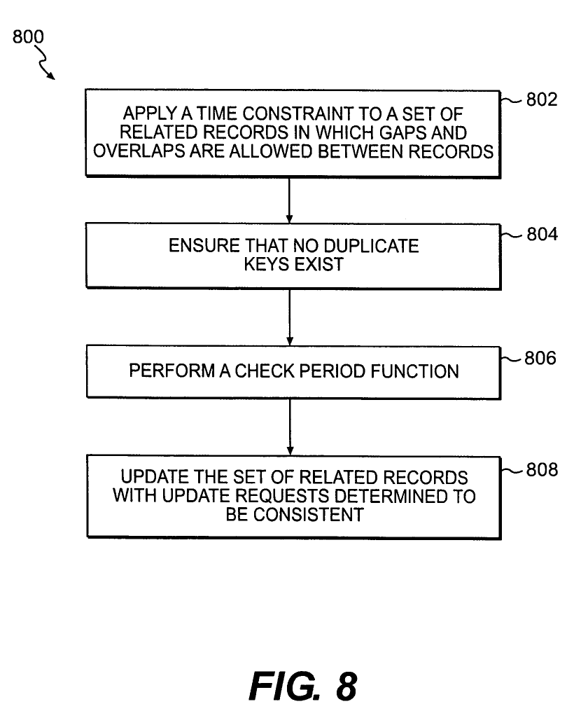

FIG. 8 is a flow chart illustrating the operation of a system 800 consistent with the principles of the present invention when time constraint (i) is applied. As illustrated, a time constraint is applied to a set of related records allowing gaps and overlaps between records (802). System 800 may ensure that no duplicate keys exist (804). System 800 may also perform a “check period” function (806). System 800 may update the set of related records with update requests determined to be consistent (808).

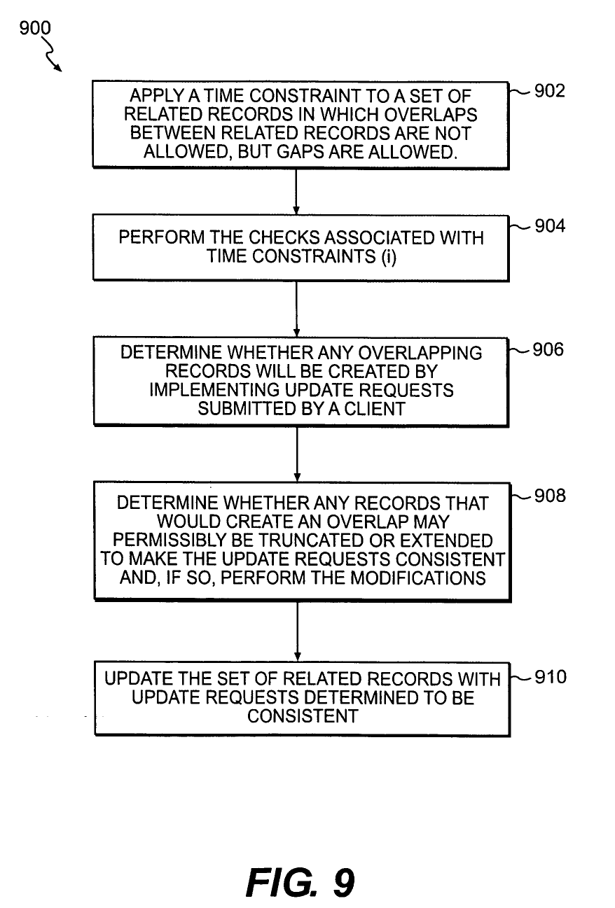

FIG. 9 is a flow chart illustrating the operation of a system 900 consistent with the principles of the present invention when time constraint (ii) is applied. As illustrated, a time constraint prohibiting overlaps between related records but allowing gaps may be applied (902). System 900 may perform operations 804, 806 described above in regard to time constraint (i) (904). System 900 may also determine whether any overlapping records would be created by implementing update requests submitted by a client (906). System 900 may determine whether any records that would create an overlap may permissibly be truncated or extended to make the update requests consistent and, if so, performing the modifications (908). System 900 may update the set of related records with update requests determined to be consistent (910).

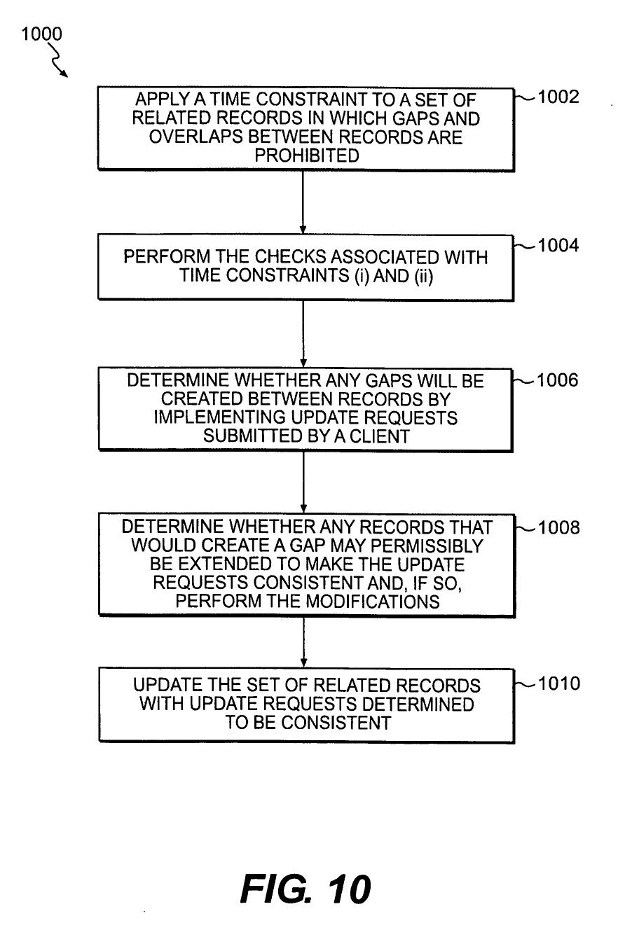

FIG. 10 is a flow chart illustrating the operation of a system 1000 consistent with the principles of the present invention when time constraint (iii) is applied. As illustrated, a time constraint prohibiting gaps and overlaps between related records may be applied (1002). System 1000 may perform operations 804, 806, 904, 906, 908, described above (1004). System 1000 may determine whether any gaps will be created between records by implementing update requests submitted by a client (1006). System 1000 may also determine whether any records that would create a gap may permissibly be extended to make the update requests consistent and, if so, perform the modifications (1008). System 1000 may update the set of related records with update requests determined to be consistent (1010).

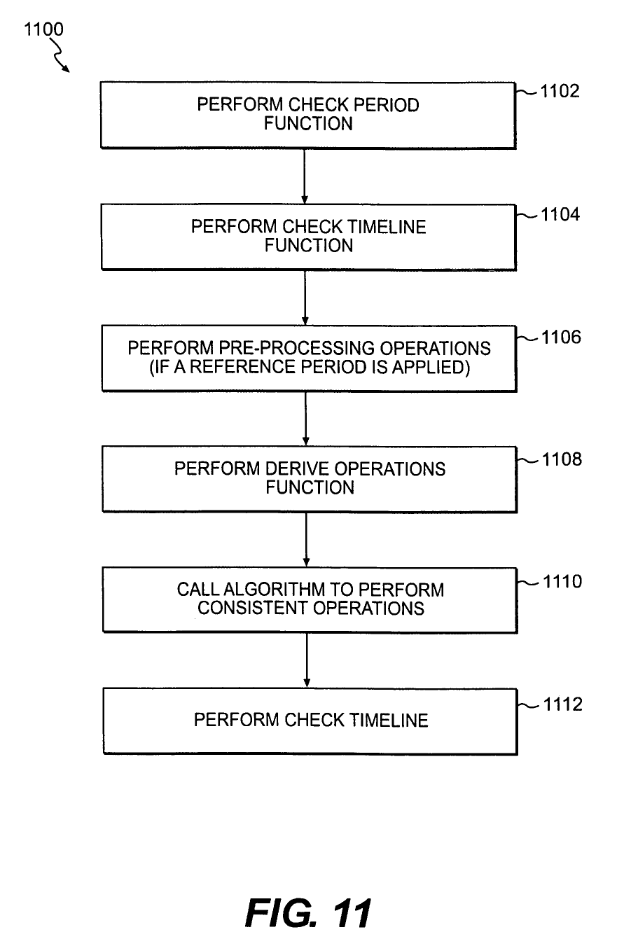

FIG. 11 is a flow chart illustrating the ordering of operations in systems and methods consistent with the principles of the present invention. After update requests are received from a client, a system 1100 may perform a “period check” function on each of the requests (1102). System 1100 may also perform a “timeline check” function (1104). If a reference period is applied to the set of records, system 1100 may perform pre-processing operations to determine if any requests to insert or update a record may be modified to bring the set of records into consistency with the reference period (1106). System 1100 may also be operative to perform a “derive operations” function (1108). After performing the “derive operations” function, system 1100 may call an algorithm operative to perform the operations deemed consistent (1110). After the consistent operations are performed, the system may perform the “timeline check” function again in order to verify that no inconsistent records are made persistent (1112).

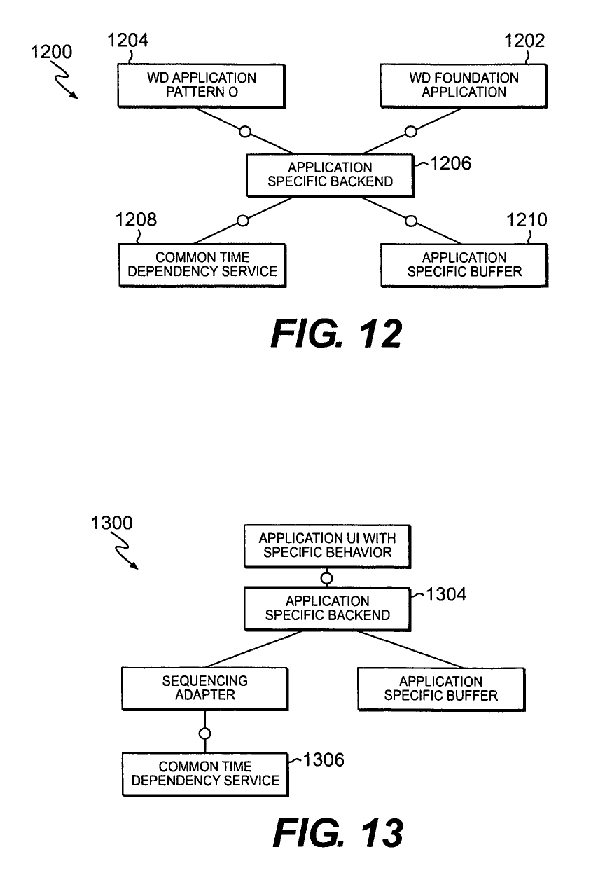

FIG. 12 illustrates one implementation of a system consistent with the principles of the present invention. System 1200 may comprise an application 1202 comprising a client interface 1204. Consistent with the principles of the present invention, client interface 1204 may comprise a user interface (UI). UI 1204 may pass update requests submitted by the user to application logic processor 1206. Logic processor 1206 may be operative to pass the update requests to a rules-processing engine 1208. Rules-processing engine 1208 may be operative to determine which requests are consistent and which are inconsistent, and to pass the results back to application logic processor 1206. Requests deemed inconsistent may be returned to UI 1204 so the user can edit or cancel the requests. Requests deemed consistent may be implemented on application-specific buffer 1210.

Another system 1300, illustrated in FIG. 13, may comprise a sequencing adaptor 1302 operative to translate user-submitted update requests from commands understood by application logic processor 1304 to commands understood by rules-processing engine 1306. Providing sequencing adaptor 1302 between application logic processor 1304 and rules engine 1306 may allow more elaborate time-dependency behavior.

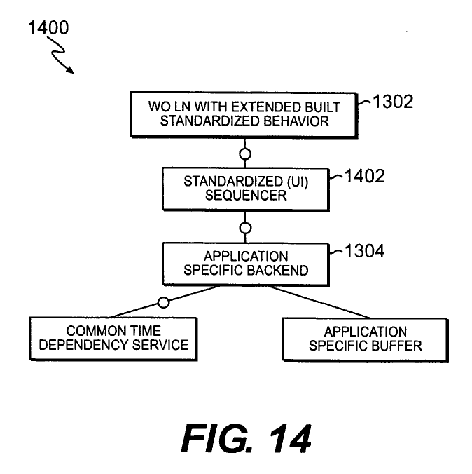

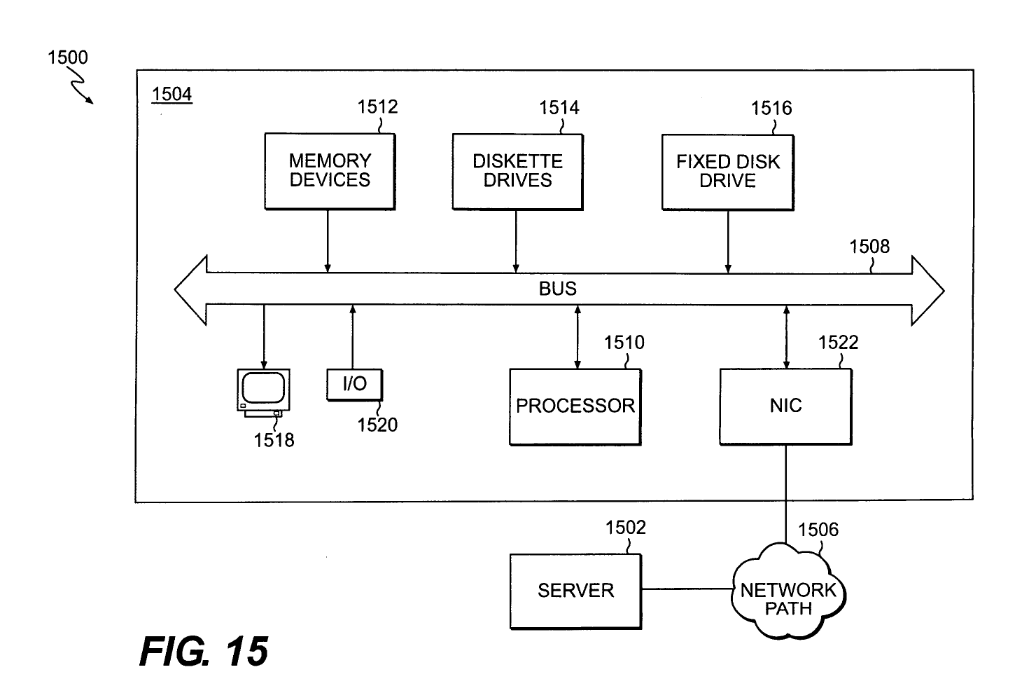

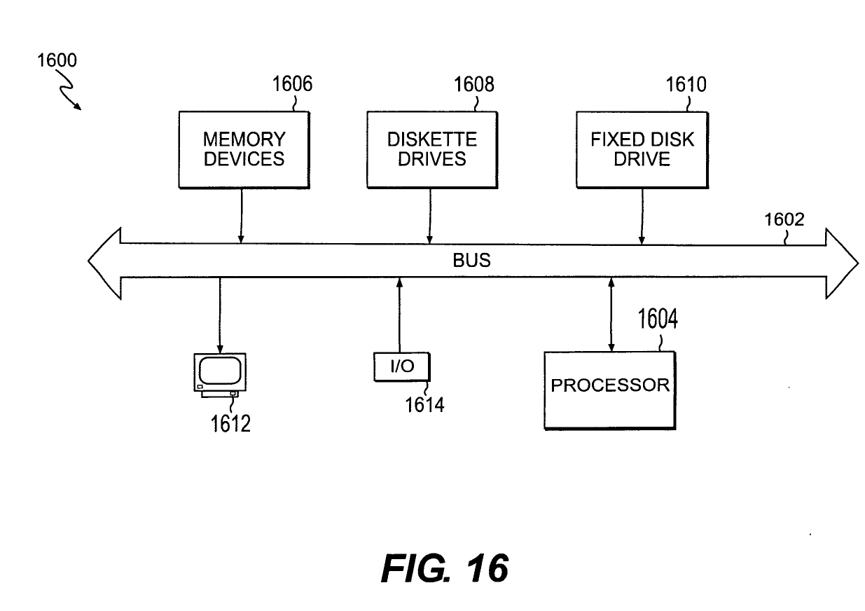

FIG. 14 illustrates a system 1400 capable of delivering more elaborate time dependent behavior than the system described in FIG. 12. System 1400 may comprise a standardized UI sequencer 1402 between user interface 1302 and logic processor 1304. In systems comprising a sequencing adaptor 1302 or a standardized UI sequencer 1402, care must be given to avoiding establishing new patterns or reusable controls, as this could affect the accurate implementation of the desired time constraints.

A computer system may be used to install a software application implementing systems and methods for managing multiple updates to time-constrained data consistent with an implementation of the present invention. The computer system may be a computer network, as shown in FIG. 15, or a stand-alone personal computer (PC), as shown in FIG. 16.

As shown in FIG. 15, a computer network 1500 for implementing a system for managing multiple updates to time-constrained data consistent with an implementation of the present invention may include a server 1502 and a stand-alone PC 1504 connected through a network path 1506. Computer network 1500 may be a local area network (LAN), where server 1502 and PC 1504 are workstations. Computer network 1500 may also be the Internet, with server 1502 hosting a web application and PC 1504 being any workstation available to a user desiring to interface with the application on server 1502. Alternatively, computer network 1500 may be a wide area network (WAN), and server 1502 and PC 1504 may lie in two separate LANs connected through the Internet.

PC 1504 may include a bus line 1508 connecting a plurality of devices such as a processor 1510, memory devices 1512 for storage of information, diskette drives 1514, a fixed disk drive 1516, a monitor 1518, other I/O devices 1520, and a network interface card (NIC) 1522. Processor 1510 may be a microprocessor such as an Intel Pentium™ chip for processing applications. Memory devices 1512 may include read-only memories (ROM) and/or random access memories (RAM). Diskette drives 1514 may include a floppy drive and/or a compact disk (CD) drive. Fixed disk drive 1516 may be a hard drive. I/O devices 1520 may include a keyboard and/or a mouse for receiving input from a user of PC 1504. Monitor 1518 may display output from processor 1510, and may also echo the input of the user. PC 1504 may be connected to network path 1506 through NIC 1522.

An application may be installed on server 1502. An individual desiring to access the application on server 1502 may use a web browser loaded on PC 1504, and may communicate with server 1502 through NIC 1522 and network path 1506. In one aspect, a software application implementing a system for managing multiple updates to time-constrained data consistent with an implementation of the present invention may be stored in PC 1504 and processor 1510 of PC 1504 may execute the software application locally within PC 1504 and interface with a web application on server 1502. Particularly, the software application may be stored on a floppy disk or a CD accessible by diskette drive 1514 or on fixed disk drive 1516. In another aspect, the software application comprising a system consistent with an implementation of the present invention may be stored in server 1502, which may execute the software application, and processor 1510 of PC 1504 may communicate with server 1502 to (i) send information to server 1502 and (ii) retrieve the results of the execution of the software application from server 1502.

Through the execution of the software application implementing a system for managing multiple updates to time-constrained data consistent with an implementation of the present invention, either locally within PC 1504 or remotely within server 1502, multiple updates to time-constrained data may be managed as described above.

Alternatively, as shown in FIG. 16, a stand-alone PC 1600 may be used for executing a software application implementing a system for managing multiple updates to time-constrained data consistent with an implementation of the present invention. PC 1600 may include a bus line 1602 connecting a plurality of devices, which may include a processor 1604, memory devices 1606 for storage of information, diskette drives 1608, a fixed disk drive 1610, a monitor 1612, and other I/O devices 1614. Processor 1604 may be a microprocessor such as an Intel Pentium™ chip for processing applications. Memory devices 1606 may include ROM and/or RAM. Diskette drives 1608 may include a floppy drive and/or a compact disk (CD) drive. Fixed disk drive 1610 may be a hard drive. Monitor 1612 may display the output of processor 1604 and may also echo the input of the user. I/O devices 1614 may include a keyboard and/or a mouse for receiving input from a user of PC 1600.

A software application comprising a system for managing multiple updates to time-constrained data consistent with an implementation of the present invention may be stored on a floppy disk or a CD accessible by diskette drive 1608 or on fixed disk drive 1610. Processor 1604 may execute the software application stored in the floppy disk the CD or the fixed disk drive 1610. An individual, through monitor 1612 and I/O devices 1614, may interact with processor 1604, which may execute the software application for managing multiple updates to time-constrained data.

Systems for managing multiple updates to time-constrained data may be integrated into a web browser or software application, or may be installed as a plug-in to an existing browser or application. Systems consistent with the principles of the present invention may also be implemented into any transactional application utilizing frames. Systems consistent with the principles of the present invention may be run on either the client side or the server side. However, systems on the client side may reduce impact on the server load, improving system efficiency. A software application implementing a system for managing multiple updates to time-constrained data consistent with an implementation of the present invention may be written in any number of programming languages, including but not limited to JavaScript, Visual Basic and Flash. Similarly, the present invention is not limited to use with certain applications, Internet browsers or operating systems.

Furthermore, the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

While certain features and embodiments of the invention have been described, other embodiments of the invention will be apparent to those skilled in the art from consideration of the specification and practice of the embodiments of the invention disclosed herein. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A method for managing updates to time-constrained data using a software application, the method comprising:
receiving a set of multiple updates submitted by a client;
determining whether the multiple updates are consistent with an applied time constraint; and
updating the set of time-constrained records with the multiple updates that are determined to be consistent;
wherein the number of records existing after implementing the consistent multiple updates is consistent with the number of records existing before implementation of the multiple updates without requiring pre-ordering of the multiple updates by the client, such that insertion of one record increases the total number of records by one, deletion of one record decreases the total number of records by one, and modifying an existing record does not change the number of existing records.

2. The method of claim 1, wherein the applied time constraint includes a reference time period against which the multiple updates are checked for consistency.

3. The method of claim 2, wherein the multiple updates that both begin and end outside the reference period are deemed inconsistent.

4. The method of claim 2, wherein the multiple updates that either begin or end outside the reference period are delimited to fall entirely within the reference period.

5. The method of claim 2, further comprising extending an existing record or a one of the multiple updates to cover an otherwise uncovered portion of the reference period to avoid creation of an inconsistency.

6. The method of claim 1, further comprising determining whether the beginning time of any of the multiple updates is later than the end time and, if so, determining that any such multiple updates are inconsistent.

7. The method of claim 1, wherein the applied time constraint is selected from one of the group consisting of (i) gaps and overlaps are allowed between related records; (ii) gaps are allowed between related records but overlaps are not; and (iii) gaps and overlaps are not allowed between related records.

8. The method of claim 1, further comprising, if an overlap exists between a previously existing record and a one of the multiple updates consisting of a new insertion, delimiting the previously existing record to eliminate the overlap.

9. The method of claim 1, wherein, if implementing the multiple updates would result in a gap between records due to the insertion of a new record and the deletion of a previously existing record, the method further comprises extending the newly created record to eliminate the gap.

10. The method of claim 1, further comprising, in the event that one of the multiple updates is deemed inconsistent, generating and displaying a message to the client indicating why the one of the multiple updates was deemed inconsistent.

11. The method of claim 1, further comprising transmitting the multiple updates to a sequencing adaptor operative to translate the multiple updates submitted by the client into a command sequence understood.

12. The method of claim 1, further comprising returning the multiple updates determined to be inconsistent to the client for editing or cancellation.

13. The method of claim 1, further comprising generating and displaying a message to the client when a one of the multiple updates is altered by the system before implementation.

14. A system for managing updates to time-constrained data, the system comprising:
an application comprising a client interface operative to allow a client to request multiple updates to a set of related records contained in a database;
a rules-processing engine operative to apply a time constraint to determine whether the requested multiple updates are consistent with the applied time constraint; and
wherein the rules-processing engine is operative to ensure that the number of records existing after implementing the consistent multiple updates is consistent with the number of records existing before implementation of the multiple updates without requiring pre-ordering of the multiple updates by the client, such that insertion of one record increases the total number of records by one, deletion of one record decreases the total number of records by one, and modifying an existing record does not change the number of existing records.

15. The system of claim 14, wherein the applied time constraint governing permissible relationships between a set of related records includes one of: (i) gaps and overlaps are allowed; (ii) no overlaps are allowed, but gaps are allowed; and (iii) gaps and overlaps are allowed.

16. The system of claim 14, wherein the applied time constraint comprises a reference time period against which all requested multiple updates are checked for consistency.

17. The system of claim 14, further comprising a sequencing adapter between the application and the rules-processing engine operative to translate a command sequence generated by the application in response to the multiple updates into one or more commands comprehensible by the rules-processing engine

18. A computer-readable medium storing a set of instructions that, when executed, performs a method for managing updates to time-constrained data, the computer-readable medium executed by the set of instructions comprising:
applying a time constraint to a set of related records contained in a database;
providing a client interface allowing a client to submit a set of multiple updates to the set of related records;
applying the time constraint to the requested multiple updates to determine the consistency of the requested multiple updates with the applied time constraint;
updating the set of records with the multiple updates determined to be consistent; and
wherein the number of records existing after implementing the consistent multiple updates is consistent with the number of records existing before implementation of the multiple updates without requiring pre-ordering of the multiple updates by the client, such that insertion of one record increases the total number of records by one, deletion of one record decreases the total number of records by one, and modifying an existing record does not change the number of existing records.

19. The computer-readable medium of claim 18, wherein the applied time constraint applied is selected from one of the group consisting of (i) gaps and overlaps are allowed between related records; (ii) gaps are allowed between related records but overlaps are not; and (iii) gaps and overlaps are not allowed between related records.

20. The computer-readable medium of claim 19, further comprising returning multiple updates determined to be inconsistent to the client for editing or cancellation.
